(19) United States
(12) Patent Application Publication
(10) Pub. No.: US 2011/0233036 A1
(43) Pub. Date: Sep. 29, 2011

(54) ROTARY KNOB

(75) Inventors: Nagatoshi Takeda, Yokkaichi-city (JP); Yoshinao Tsujiya, Yokkaichi-city (JP)

(73) Assignee: SUMITOMO WIRING SYSTEMS, LTD., Yokkaichi-city, Mie (JP)

(21) Appl. No.: 13/139,159

(22) PCT Filed: Feb. 18, 2010
(86) PCT No.: PCT/JP2010/001040

§ 371 Date: Jun. 10, 2011

(30) Foreign Application Priority Data
Jun. 30, 2009 (JP) 2009-155178

(51) Int. Cl. H01H 9/00

(52) U.S. Cl. 200/316

(57) ABSTRACT

A rotary knob including: a knob main body having a peripheral wall that has a recess on an inner peripheral surface; a light guide member including a light guide section, a restriction section, and a light emitting surface in sequence; and a decorative member including an engagement section and a ring-like section that covers a front end of the peripheral wall. The recess is defined by a pair of opposed surfaces and a bottom surface. The light guide section is fitted into a space between the opposed surfaces. The restriction section includes a contact portion that protrudes contacts the peripheral wall. When the ring-like section contacts with the restriction section, the decorative member prevents the light guide member from moving. The peripheral wall includes a holding portion that pinches the light guide section in cooperation with the bottom surface.

This is a National Stage of Application No. PCT/JP2010/001040 filed Feb. 18, 2010, which claims priority to Japanese Application No. 2009-155178 filed Jun. 30, 2009. Each disclosure of the prior applications is hereby incorporated by reference herein in their entirety.

This disclosure relates to a rotary knob that is rotatably mounted on an operation panel or the like in a vehicle room.

### BACKGROUND

A rotary knob has been discussed in, for example, Patent Document 1 (JUM SHO 62 (1987)-30189 A). The rotary knob includes a knob main body and a luminous element provided on the knob main body at its suitable position. The luminous element serves to indicate an amount of rotation of the rotary knob in accordance with a rotary position of the luminous element.

Specifically, as shown in FIG. 11, a rotary knob 100 includes a knob main body 101 that is pinched and turned by an operator or the like, and a light guide member 102 that constitutes the luminous element. The knob main body 101 is formed into a cylindrical configuration. A cut-out space 103 is provided in the cylindrical knob main body 101 from a distal end surface 101a to a peripheral surface 101b. The light guide member 102 is made of a material that disperses lights that enter the light guide member 102, so that a surface on the light guide member 102 illuminates. The light guide member 102 is inserted into the cut-out space 103 in the knob main body 101.

Such rotary knob 100 is rotatably mounted on an operation panel or the like of an instrument. When lights from a light source or the like inside the operation panel irradiate the light guide member 102, the luminous element (the light guide member 102) illuminates (or emits lights).

Some rotary knobs to be mounted on equipments require a hollow structure, that is, a knob main body having a small thickness cylindrical structure. In such rotary knob, since the knob main body is the cylindrical structure having a small thickness, the light guide member to be attached to the knob main body must have a small thickness (that is, a size in a radial direction). Consequently, it is difficult to stably attach the light guide member having the small thickness to the knob main body having the small thickness.

When the rotary knob provided with the knob main body having the small thickness has a decorative member and a part of the decorative member is attached to the knob main body so that a part of the decorative member is inserted into the knob main body, an internal space in the rotary knob will become narrow on account of the decorative member inserted in the knob main body. Consequently, one must ensure that the rotary knob includes adequate internal space, as well as ensure stability of the light guide member, even if the decorative member is attached to the knob main body. For example, if the decorative member has a cylindrical inserting section to secure the decorative member to the knob main body, when the cylindrical inserting section is inserted into the knob main body along its inner peripheral surface, the cylindrical inserting section of the decorative member is disposed in the cylindrical interior in the knob main body. Therefore, the internal space in the knob main body is reduced in comparison with a single knob main body.

### SUMMARY

The exemplary embodiments are directed to a rotary knob that can ensure an adequate internal space even if a part of a decorative member is inserted into and is attached to a knob main body and that can stably hold a light guide member and can exert a satisfactory display in the light guide member, after the light guide member is attached to the knob main body.

A rotary knob of the exemplary embodiments is rotatably mounted on a panel. The rotary knob comprises: a knob main body including a tubular peripheral wall that protrudes from a front surface of the panel when the rotary knob is mounted on the panel, the peripheral wall being provided in an inner peripheral surface at a particular position in a peripheral direction of the peripheral wall with a fixing recess that extends from a rear end to a front end of the peripheral wall and is concaved outward in a radial direction of the peripheral wall; a light guide member including a light guide section that extends along the fixing recess so that at least an outer portion of the light guide section in the radial direction is fitted into the fixing recess, a restriction section that is provided on a front end side of the light guide section and restrains the light guide member from moving along an extending direction of the fixing recess with respect to the knob main body, and a light emitting surface that is provided on a front end side of the restriction section, is exposed outward from the rotary knob at a front end side over the peripheral wall, and illuminates when lights enter the light guide section, a rear end surface of the light guide section being adapted to define an incident surface for lights; and a decorative member including an engagement section that is inserted inside the peripheral wall along an inner peripheral surface of the peripheral wall so as to be engaged with the peripheral wall, a ring-like section that covers the peripheral wall so that the front end of the peripheral wall is exposed outward when the engagement section is engaged with the peripheral wall. The fixing recess is defined by a pair of opposed surfaces that are spaced apart from each other in the peripheral direction of the peripheral wall and are faced to each other and by a bottom surface that connects outer ends of the pair of opposed surfaces in the radial direction of the peripheral wall. The light guide section of the light guide member extends along the pair of opposed surfaces so that at least an outer portion of the light guide section in the radial direction of the peripheral wall is fitted into a space between the pair of opposed surfaces. The restriction section includes a contact portion that protrudes in the peripheral direction of the peripheral wall over the light guide section and that contacts with the peripheral wall at a front end side of the contact portion. The engagement section of the decorative member is located inside at least the light guide member in the peripheral direction of the peripheral wall. The decorative member is adapted to prevent the light guide member from moving in the extending direction of the fixing recess with respect to the knob main body when the decorative member is attached to the peripheral wall and the ring-like section contacts with a front end of the restriction section of the light guide member. The peripheral wall includes a holding portion that is provided at a position opposed to the bottom surface of the fixing recess and pinches the light guide section at both sides of the radial direction of the peripheral wall in cooperation with the bottom surface of the fixing recess.

As described above, even if a part of the decorative member is inserted into and is attached to the knob main body, it is possible to ensure a sufficient internal space in the rotary knob and it is possible for the light guide member to carry out a stable and satisfactory display after the light guide member is attached to the knob main body.

### BRIEF DESCRIPTION OF THE DRAWINGS

FIG. 1 is an exploded perspective view of an exemplary embodiment of a rotary knob.

FIG. 2 is a front elevation view of a knob main body of the rotary knob shown in FIG. 1.

FIG. 3A is a longitudinal section view of the knob main body taken along lines IIIA-IIIA in FIG. 2. FIG. 3B is a longitudinal section view of the knob main body taken along lines IIIB-IIIB in FIG. 2.

FIG. 4 is a cross section view of the knob main body taken along lines IV-IV in FIG. 3A.

FIG. 5A is a longitudinal section view of the knob main body taken along lines VA-VA in FIG. 2. FIG. 5B is the longitudinal section view similar to FIG. 5A, illustrating the knob main body to which a pointer is attached.

FIG. 6 is a longitudinal section view of the knob main body taken along a central axis that passes latching apertures in latching projections on a peripheral wall of the rotary knob and a main body base.

FIG. 7A is a plan view of a pointer (a light guide member) of the rotary knob.

FIG. 7B is a longitudinal section view of the pointer taken along lines VIIB-VIIB in FIG. 7A.

FIG. 8A is a longitudinal section view of a decorative member.

FIG. 8B is an enlarged section view of a part of the decorative member shown in FIG. 8A.

FIG. 9A is a front elevation view of the rotary knob, illustrating the rotary knob that is mounted on an operation panel.

FIG. 9B is a bottom view of the rotary knob that is mounted on the operation panel.

FIG. 10 is an enlarged section view of the rotary knob taken along lines X-X in FIG. 9A.

FIG. 11 is an exploded perspective view of a related rotary knob.

### DETAILED DESCRIPTION OF EMBODIMENTS

By referring now to the drawings, an exemplary embodiment of a rotary knob in accordance with the present disclosure will be described below.

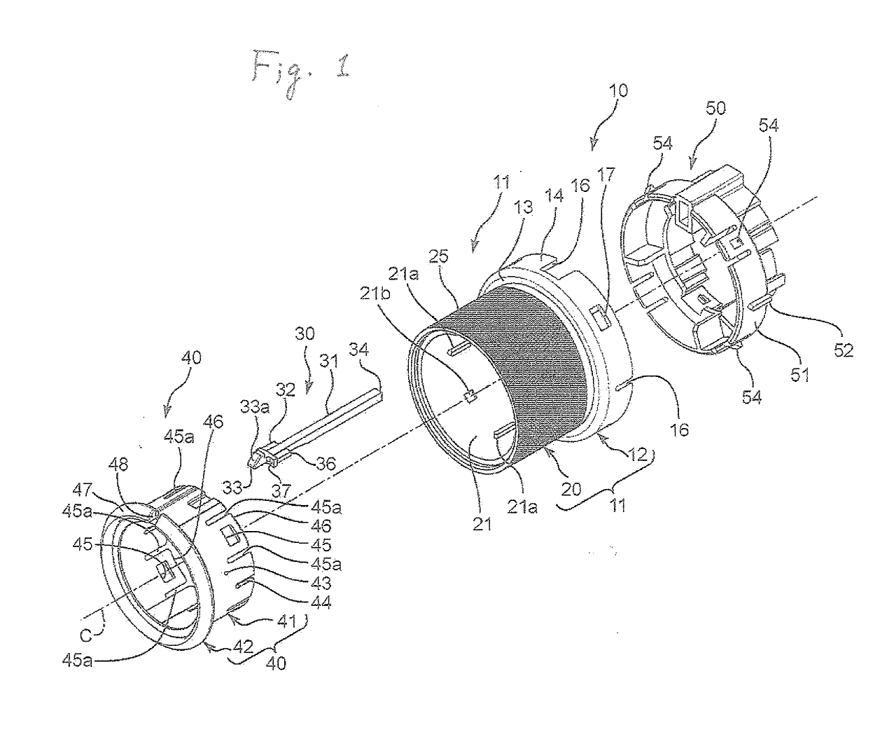

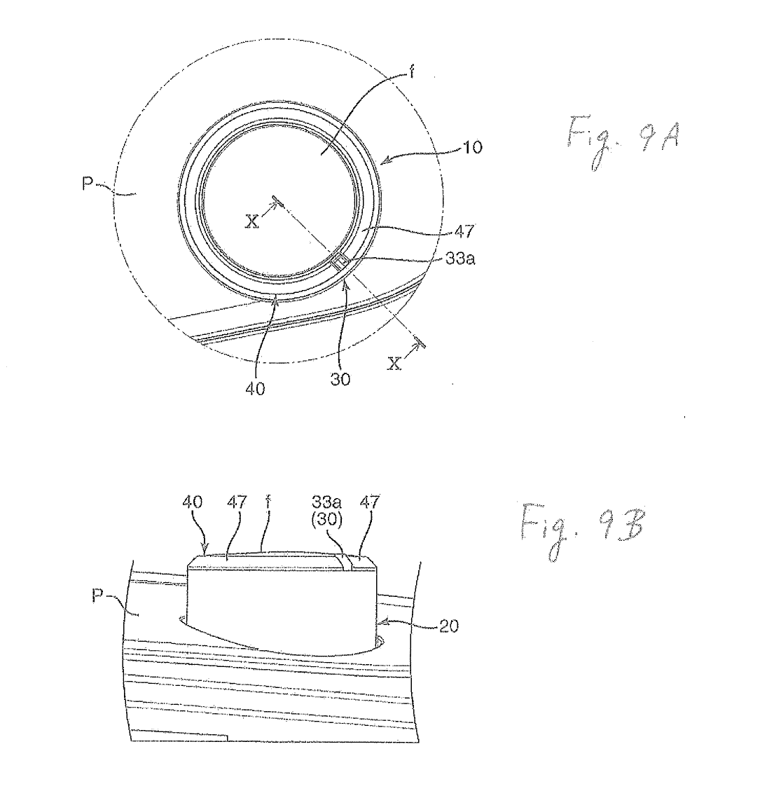

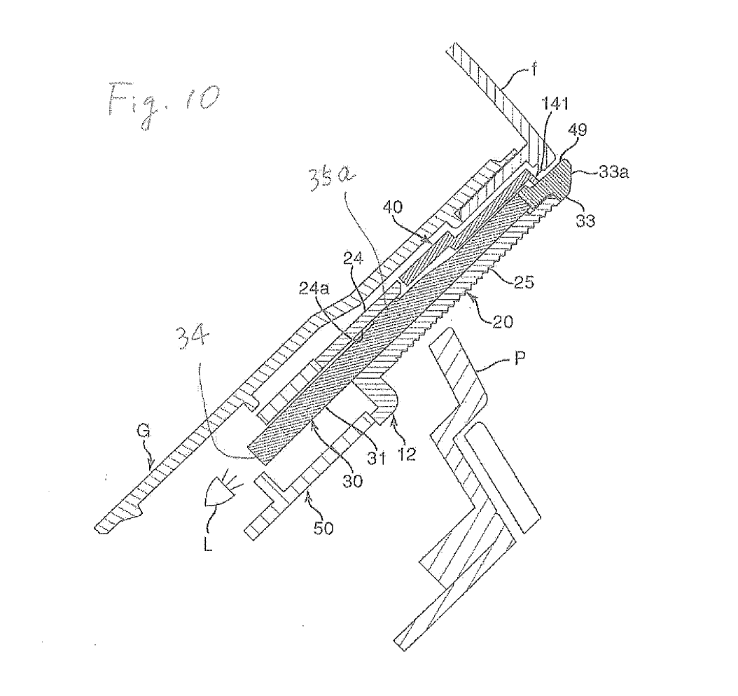

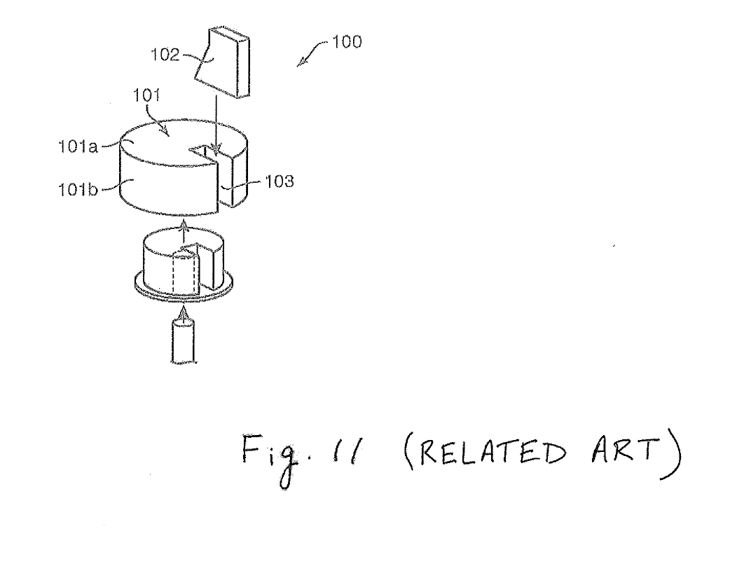

As shown in FIG. 1, a rotary knob 10 in an exemplary embodiment of the present disclosure includes a knob main body 11 that is pinched and turned by an operator or the like, a pointer (a light guide member) 30 that constitutes a display section of the knob main body 11, a decorative member 40 that is attached to a front end side of the knob main body 11, and a connecting member 50 that is attached to a rear end side of the knob main body 11. The rotary knob 10 protrudes its front end side from a front surface of an operation panel P in a vehicle room and is rotatably mounted on the operation panel P (see FIG. 9A to FIG. 10).

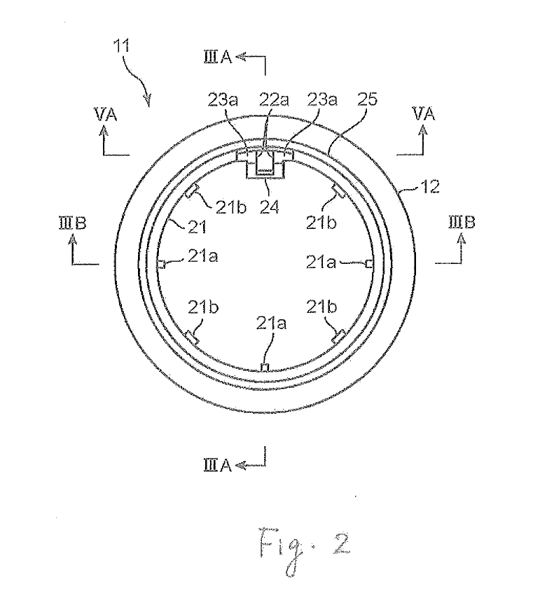

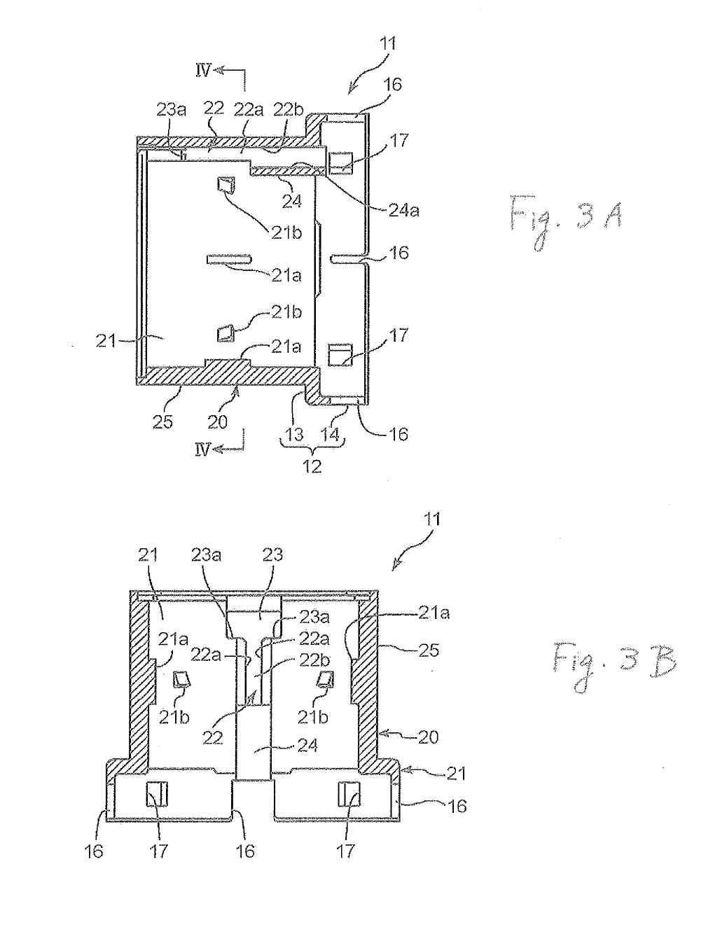

As shown in FIG. 1 to FIG. 5B, the knob main body 11 includes a tubular peripheral wall 20 that protrudes from the front surface of the operation panel P when the rotary knob 10 is mounted on the operation panel P. A main body base 12 is connected to a rear end of the peripheral wall 20 so that the main body base 12 is disposed inside the operation panel P when the rotary knob 10 is mounted on the operation panel P.

The peripheral wall 20 is formed into a cylindrical shape having a small thickness in a radial direction (that is, a thin wall). The peripheral wall 20 includes an inner peripheral surface 21 having a fixing recess 22 that extends from a rear end (that is, the main body base 12) to a front end of the peripheral wall 20 and that is concaved outward in the radial direction of the peripheral wall 20. The peripheral wall 20 is provided at a front end side of the fixing recess with a wide recess 23 that has a width greater than that of the fixing recess 22 in a peripheral direction. The wide recess 23 is continued to the fixing recess 22. Here, “a radial direction” in the present exemplary embodiment defines a radial direction of the peripheral wall 20 and “a peripheral direction” defines a circumferential direction of the peripheral wall 20.

The fixing recess 22 is defined by a pair of opposed surfaces 22a that are spaced apart from each other in the peripheral direction so as to be faced to each other and by a bottom surface 22b that connects outer ends of opposed surfaces 22a in the radial direction. In other words, the fixing recess 22 extends along a central axis C of the peripheral wall 20 and is formed into a groove-like configuration having a given width and depth. The fixing recess 22 is provided on the inside of the peripheral wall 20 (i.e., on the inner peripheral surface 21) in the radial direction and includes a holding portion 24 for restraining the pointer 30 within the knob main body 11 in the radial direction.

The holding portion 24 can restrain the pointer 30 in the radial direction by pinching the pointer 30 at both sides 22a in the radial direction in cooperation with the bottom surface 22b of the fixing recess 22. The holding portion 24 in the present exemplary embodiment straddles the fixing recess 22 at its rear end. Thus, when the pointer 30 is disposed in the fixing recess 22, an intermediate portion of the pointer 30 is surrounded by the rear end of the fixing recess 22 and the holding portion 24.

The wide recess 23 shares the bottom surface 22b with the fixing recess 22 and extends to the fixing recess 22 along the central axis C. The wide recess 23 is provided on a rear end with a retraction stopper 23a with which a part (a rear contact portion 36) of the pointer 30 contacts from its front end side. The retraction stopper 23a is provided on an area that spreads from a front end of the fixing recess 22 to the peripheral direction (a width direction). Specifically, the retraction stopper 23a extends from a peripheral edge around the bottom surface 22b of the wide recess 23 toward the center of the knob main body 11 in the radial direction and defines a surface directed to the distal end side.

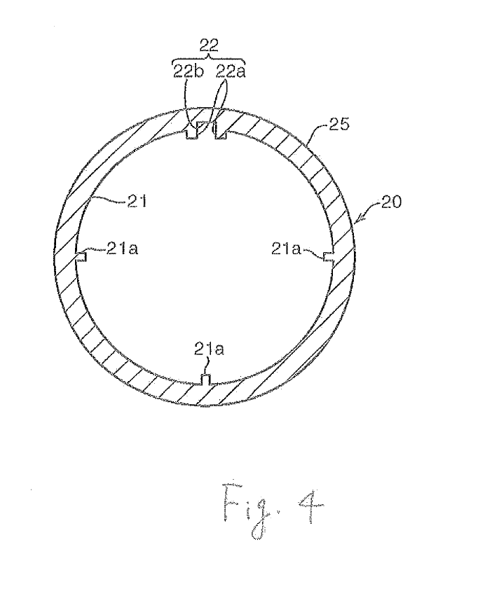

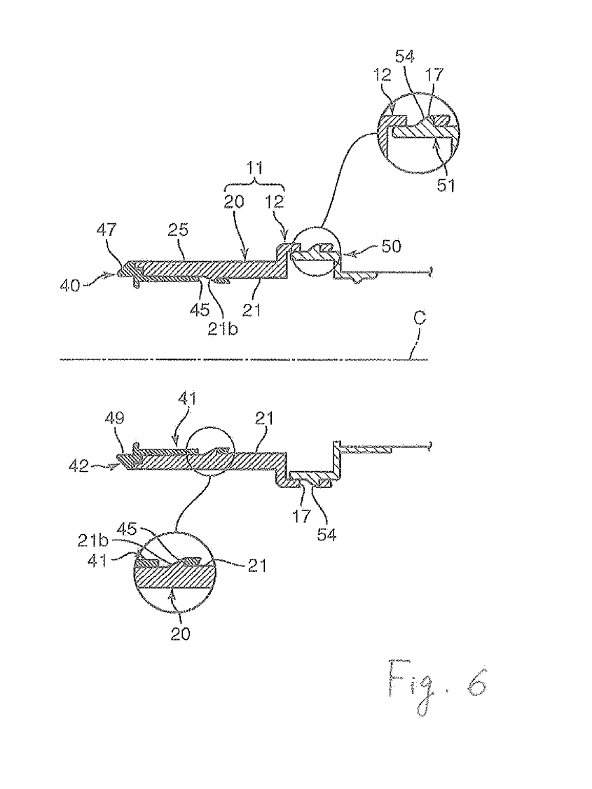

The peripheral wall 20 is provided on its inner peripheral surface 21 with a plurality of ridges 21a, which extend along the central axis C, as well as the fixing recess 22. These ridges 21a are spaced apart from one another in the peripheral direction of the inner peripheral surface 21 (see FIG. 4). Furthermore, the peripheral wall 20 is provided on its inner peripheral surface 21 with a plurality of latching projections 21b that protrude from the inner peripheral surface 21 toward a center in the radial direction. These latching projections 21b are disposed between the adjacent ridges 21a that are spaced apart from one another in the peripheral direction of the inner peripheral surface 21. These ridges 21a and latching projections 21b are used when the decorative member 40 is attached to the knob main body 11. Specifically, when the decorative member 40 is inserted into the inside of the peripheral wall 20, the ridges 21a serve to guide the decorative member 40 in its inserting direction. The latching projections 21b serve to engage an engagement section 41 of the decorative member 40 with the inside of the peripheral wall 20 (see FIG. 6).

An outer peripheral surface 25 on the peripheral wall 20 is subjected to an anti-slip treatment. In the present exemplary embodiment, the outer peripheral surface 25 on the peripheral wall 20 is knurled as the anti-slip treatment.

When the rotary knob 10 is mounted on the operation panel P, the main body base 12 is disposed in the inside of the operation panel P. An outer diameter of the main body base 12 is greater than that of the peripheral wall 20. Specifically, the main body base 12 includes an annular standing-up portion 13 that spreads from a rear end (an end at a side of the main body base 12) of the peripheral wall 20 in the radial direction, and a latching section 14 that extends backward from a front end of the annular standing-up portion 13 in a standing-up direction, that is, an outer peripheral edge of the annular standing-up portion 13.

The latching section 14 is formed into a short tubular configuration that extends backward from the outer peripheral edge of the standing-up portion 13 in parallel to the peripheral wall 20. When the connecting member 50 is attached to the knob main body 11, the latching section 14 is engaged with the connecting member 50. The latching section 14 is provided with a plurality of cut-out spaces 16 in the peripheral direction. Each of the cut-out spaces 16 extends from a rear end of the latching section 14 to a distal end of the portion 14. The latching section 14 is also provided with a plurality of latching apertures 17 in the peripheral direction. Each of the latching apertures 17 passes through the latching section 14.

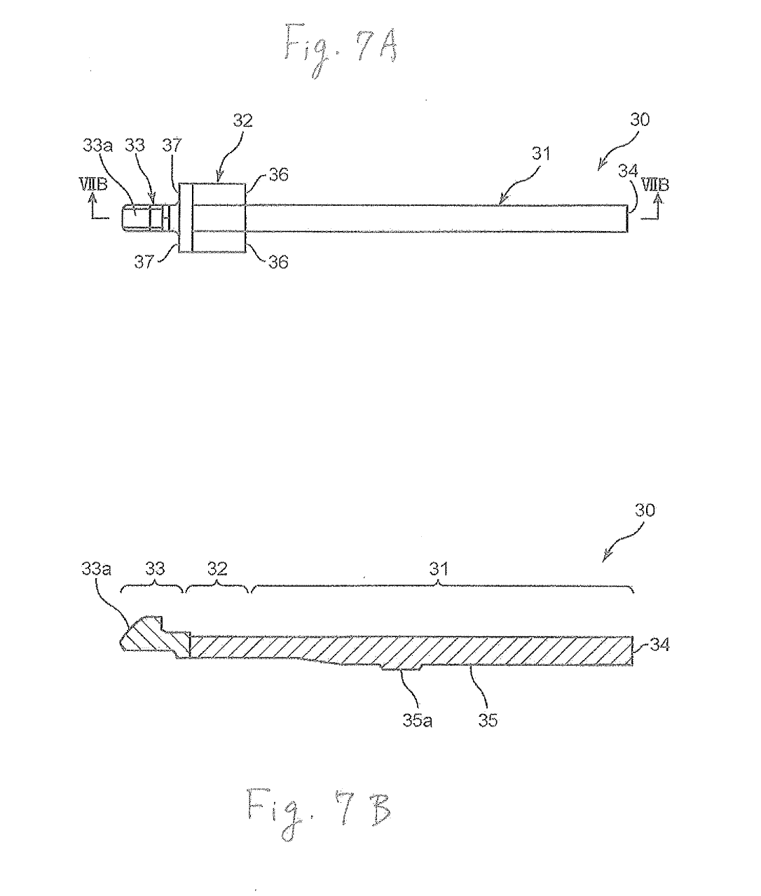

As shown in FIGS. 7A and 7B, the pointer 30 is a substantially bar-like light guide member that extends along the central axis C and includes a light guide section 31, a restriction section 32, and an light emitting section 33.

The light guide section 31 extends along the fixing recess 22 so that at least an outer side part (an upper part in FIG. 7B) of the light guide section 31 is fitted into the fixing recess 22. That is, the light guide section 31 extends along the pair of opposed surfaces 22a, 22a so that at least the outer side part of the light guide section 31 is fitted into a space between the pair of opposed surfaces 22a, 22a of the fixing recess 22.

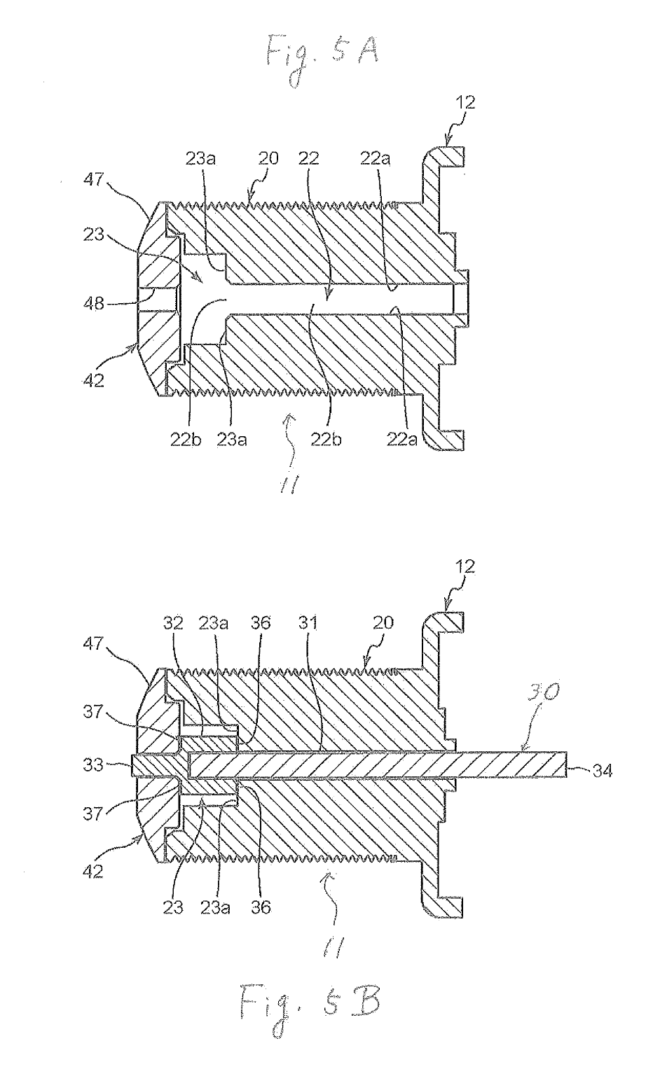

Specifically, a width (a size in upper and lower directions in FIG. 7A) of the light guide section 31 is constant from its front end to its rear end and a thickness (a size in upper and lower directions in FIG. 7B) of the rear end of the light guide section 31 is greater than that of a front end of the section 31. The width of the light guide section 31 is set to be a distance between the pair of opposed surfaces 22a, 22a of the fixing recess 22, that is, a size in which the pointer 30 cannot stagger in the fixing recess 22 in the peripheral direction (the width direction) when the pointer 30 is fitted into the space between the opposed surfaces 22a, 22a. The light guide section 31 has a length (a size in right and left directions in FIG. 5B) in which the rear end of the pointer 30 extends over a rear end of the peripheral wall 20. The pointer 30 is provided on the rear end with an incident surface 34. That is, the rear end surface of the light guide section 31 defines the incident surface 34 for lights that enter the light guide section 31 (the pointer 30).

Furthermore, the light guide section 31 is provided on an intermediate part with a contact surface 35a. As shown in FIG. 7B, the contact surface 35a protrudes from the bottom surface 35 (an inner surface in the radial direction) of the light guide section 31 in a thickness direction of the light guide section 31. When the pointer 30 is fitted into the fixing recess 22, the contact surface 35a contacts the holding portion 24. As shown in FIG. 10, the contact surface 35a is sized to contact only a part of surface 24a on the holding portion 24 opposed to the bottom surface 35 of the light guide section 31. Thus, since the contact surface 35a contacts with a part of the surface 24a of the holding portion 24, a contact area between the light guide section 31 and the holding portion 24 becomes small, thereby reducing a friction force upon fitting the pointer 30 into the fixing recess 22 and facilitating an assembling work of the pointer 30.

Restriction section 32 is provided on a front end side of the light guide section 31 to restrain the pointer 30 from moving along an extending direction of the fixing recess 22 with respect to the knob main body 11. The restriction section 32 has a rear contact portion (a contact portion) 36 that protrudes in the peripheral direction over the light guide section 31 and the restriction section 32 contacts with the peripheral wall 20 (in more detail, the retraction stopper 23a of the wide recess 23) at a front end side of the light guide section 31. Specifically, the restriction section 32 is provided on the front end side of the light guide section 31 of the pointer 30 and is a wide section that protrudes to both sides in the peripheral direction over the light guide section 31. In the present exemplary embodiment, the restriction section 32 is formed into a substantially rectangular shape in plan view (see FIG. 7A). A forward directed surface of the front end of the rectangular restriction section 32 defines a front contact portion 37 while a backward directed surface of the rear end of the restriction section 32 defines a rear contact portion 36.

The light emitting section 33 has a light emitting surface 33a that is exposed outward from the rotary knob 10 at the front end side over the peripheral wall 20 and the light emitting section 33 is provided on the front end side of the restriction section 32. The light emitting surface 33a illuminates when lights enter the light guide section 31. The light emitting surface 33a is provided on a front end of the light emitting section 33 and is formed into a slant surface that accords with a chamfer formed on a ring-like section 42 of the decorative member 40.

The pointer 30 constructed above is made of, for example, a translucent material. In the pointer 30 of the present exemplary embodiment, a rear end side part is made of a high transparency material while a front end side part is made of a low transparency material (see hatching portions of the pointer 30 shown in FIG. 5B and FIG. 7B). Specifically, the restriction section 32 of the pointer 30, exclusive of the light guide section 31 and the portion that protrudes over the light guide section 31 in the peripheral direction, is made of a high transparency material while the light emitting section 33 and the protruding portion of the restriction section 32 are made of a transparency material lower than that of the restriction section 32 exclusive of the light guide section 31 and the protruding portion. Thus, the light emitting surface 33a on the pointer 30 has a transparency lower than that of the incident surface 34.

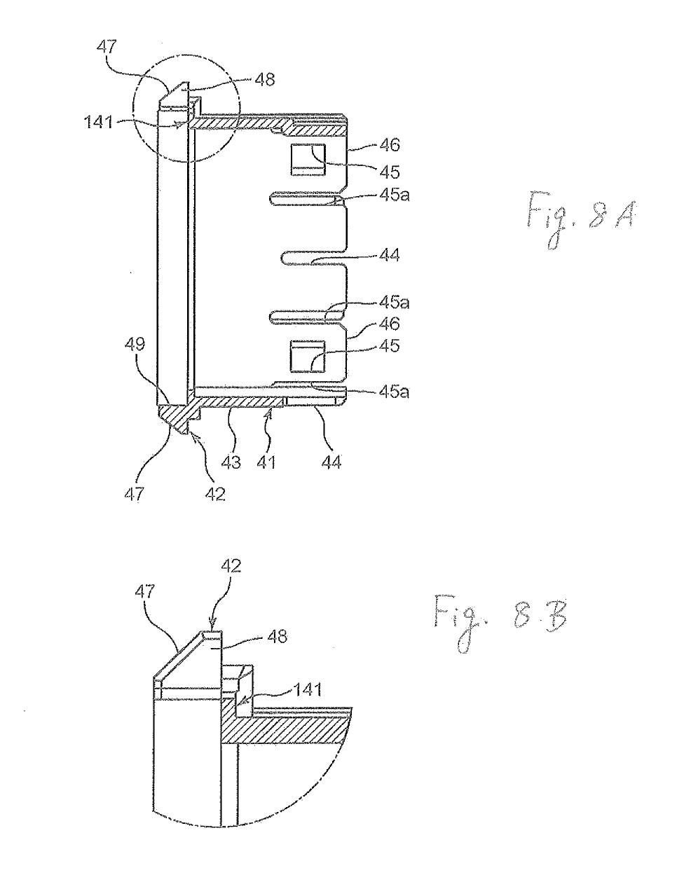

As shown in FIGS. 8A and 8B, the decorative member 40 is formed into a cylindrical configuration and includes an engagement section 41 and a ring-like section 42 provided on a front end side of the engagement section 41. When the decorative member 40 is attached to the peripheral wall 20 and the ring-like section 42 contacts with the restriction section 32 of the pointer 30 (in more detail, the front contact portion 37 of the restriction section 32) from the front end side of the section 32, the decorative member 40 restrains the knob main body 11 and pointer 30 from moving with respect to each other in the extending direction of the fixing recess 22 (see FIG. 5B). In the present exemplary embodiment, a chromium plating is applied to a whole surface of the decorative member 40.

When the engagement section 41 is inserted into the inside of the peripheral wall 20 along the inner peripheral surface 21 of the peripheral wall 20, the engagement section 41 is engaged with the peripheral wall 20. Specifically, the engagement section 41 includes an outer peripheral surface 43 having an outer diameter corresponding to an inner diameter of the inner peripheral surface 21 of the peripheral wall 20 (see FIG. 6). A length of the engagement section 41 in a direction of the central axis C is set to define a slight clearance between the holding section 24 and the engagement section 41 when the engagement section 41 is attached to the peripheral wall 20 (see FIG. 10).

The engagement section 41 is provided with a supporting portion 141 on an inside position in the radial direction at a front end side over the light guide section 31 of the pointer 30 (immediately behind the light emitting section 33 in the present exemplary embodiment), that is, a position facing to the front end side. The supporting portion 141 extends outward from the engagement section 41 in the radial direction. When the decorative member 40 is attached to the peripheral wall 20, a front end of the supporting portion 141 contacts with an inner surface of the front end side in the radial direction so that the front end of the pointer 30 is pressed onto the peripheral wall 20 (see FIG. 10). Specifically, the engagement section 41 is provided with the supporting portion 141 on a position corresponding to a cut-out space 48 in the ring-like section 42 and a position immediately behind the light emitting section 33.

The engagement section 41 is also provided with cut-out spaces 44, which extend along the ridges 21a, on a position corresponding to the ridges 21a on the inner peripheral surface 21 of the peripheral wall 20. When the engagement section 41 is inserted into the inside of the peripheral wall 20, the ridges 21a on the inner peripheral surface 21 of the peripheral wall 20 enter the cut-out spaces 44, so that the cut-out spaces 44 guide the decorative member 40 straightly toward the rear end side of the peripheral wall 20 along the ridges 21a.

The engagement section 41 is also provided in a position corresponding to the latching projections 21b on the inner peripheral surface 21 of the peripheral wall 20 with latching apertures 45. The latching apertures 45 pass through the engagement section 41 in the radial direction. The engagement section 41 is also provided on both sides of each latching aperture 45 with latching cut-out spaces 45a that extends from the rear end to the front end of the engagement section 41. The latching cut-out spaces 45a define a tongue piece 46 having a free rear end on a peripheral edge portion around the latching aperture 45. When the engagement section 41 is inserted into the inside of the peripheral wall 20, the rear end of each tongue piece 46 is deflected inward in the radial direction to permit the latching projection 21b to pass onto each tongue piece 46 and then the rear end returns to the original position. Thus, the latching projections 21b on the peripheral wall 20 are engaged with the latching apertures 45 in the decorative member 40 (see FIG. 6). That is, the decorative member 40 is engaged with the knob main body 11.

When the engagement section 41 is engaged with the peripheral wall 20, the ring-like section 42 is exposed outward to cover the peripheral wall 20 from its front end side. The ring-like section 42 is located at the front end side of the peripheral wall 20 and has a slant surface (a chamfer) 47 that is directed inward in the radial direction from the front end of the peripheral wall 20. The ring-like section 42 is provided on a position corresponding to the light emitting section 33 of the pointer 30 with a cut-out space 48. The cut-out space 48 has a clearance into which the front end of the pointer 30, that is, the light emitting section 33 is fitted. The front end of the light emitting section 33 that protrudes outward from the peripheral wall 20 is fitted into the cut-out space 48. Then, since the light emitting surface 33a of the light emitting section 33 and the chamfer (the slant surface) 47 have the same slant angles, both surfaces 47 and 33a are smoothly continued to each other (see FIG. 9B). A lid member f (see FIG. 9A and FIG. 10) is fitted into an opening 49 surrounded by the chamfer 47 so as to close the opening 49, when the rotary knob 10 is mounted on the operation panel P.

When the rotary knob 10 is mounted on the operation panel P, the connecting member 50 serves to interconnect the rotary knob 10 and a rotary shaft G (see FIG. 10) that extends from an instrument (not shown) to be operated by the rotary knob 10. Specifically, as shown in FIGS. 1 and 6, the connecting member 50 is formed into a short tubular member and has an inserting section 51 that can enter the latching section 14 of the main body base 12. The inserting section 51 has an outer peripheral surface with an outer diameter corresponding to an inner diameter of the inner peripheral surface of the latching section 14 of the main body base 12. The inserting section 51 is provided on an outer peripheral surface at a position corresponding to the cut-out spaces 16 in the latching section 14 of the main body base 12 with ridges 52 that extend along the cut-out spaces 16.

The inserting section 51 is also provided on its outer peripheral surface at a position corresponding to the latching apertures 17 in the latching section 14 of the main body base 12 with latching projections 54 that protrude outward from the outer peripheral surface of the section 51 in the radial direction. Thus, the latching projections 54 of the connecting member 50 are engaged with the latching apertures 17 in the latching section 14, so that the connecting member 50 is engaged with the knob main body 11. At this time, the incident surface 34 on the rear end of the pointer 30, that is, the rear end of the light guide section 31 is exposed outward without being covered with the connecting member 50 (see FIG. 10).

As shown in FIG. 9A and FIG. 10, the rotary knob 10 constructed above is mounted on the operation panel P in the vehicle room so that the front end side of the peripheral wall 20 protrudes from the aperture in the operation panel P. At this time, the lid member f is fitted into the opening 49 in the decorative member 40 and the rotary shaft G is inserted into the hollow rotary knob 10. Thus, the rotary knob 10 can rotate about the rotary shaft G. A light source L (see FIG. 10) is disposed at a position opposed to the incident surface 34 located at the rear end of the light guide section 31 of the pointer 30. When the rotary knob 10 is turned, the light source L is turned together with the incident surface 34, so that the light source L is always opposed to the incident surface 34. Lights from the light source L enter the pointer 30 (the light guide section 31) through the incident surface 34 and the lights are dispersed in the light emitting section 33 after the lights reach the light emitting section 33 through the light guide section 31. Thus, the light emitting surface 33a on the light emitting section 33 illuminates.

According to the rotary knob 10 constructed above, since the pointer 30 is restrained by the decorative member 40 in which the engagement section 41 is inserted into the inside of the peripheral wall 20, it is possible to stably attach the pointer 30 to the knob main body 11 and to carry out a satisfactory display without increasing a thickness of the peripheral wall 20.

Specifically, since the engagement section 41 of the decorative member 40 is located inside the pointer 30 in the radial direction in the peripheral wall 20, the recess (that is, the fixing recess) 22 can effectively position the light guide section 31, even if a thickness of the peripheral wall 20 is not increased and the light guide section 31 is not surrounded from its outside by the peripheral wall 20. Thus, even if the engagement section 41 is located inside the peripheral wall 20 in the radial direction, it is possible to restrain the rotary knob 10 from increasing the whole thickness. On the other hand, even if the thin pointer 30 is combined with such peripheral wall 20, the fixing recess 22 in the inner peripheral surface 21 on the peripheral wall 20 can pinch the light guide section 31 of the pointer 30 in the peripheral and radial directions and the decorative member 40 can restrain the pointer 30 so as to prevent the pointer 30 from moving in the fixing recess with respect to the knob main body 11 in the extending direction of the fixing recess 22. Thus, the pointer 30 can be stably attached to the knob main body 11.

Specifically, in the peripheral wall 20 in which the engagement section 41 inserted inside the peripheral wall 20 is located inside the pointer 30 in the radial direction, the fixing recess 22 positions the light guide section 31, so that the inside of the light guide section 31 in the radial direction is exposed, the thickness of the peripheral wall 20 becomes small in comparison with the case where the light guide section 31 is surrounded from the outside in the radial direction. Since the engagement section 41 is disposed in the vicinity of the inside of the light guide section 31 in the radial direction in the peripheral wall 20, it is possible to restrain the peripheral wall 20, pointer 30, and engagement section 41 from increasing the whole thickness of them. Consequently, it is possible to maintain a size of an internal space defined in the rotary knob 10. In addition, the pair of opposed surfaces 22a in the fixing recess 22 can pinch both sides of at least the outer side part of the light guide section 31 in the radial direction regardless the thin portion of the peripheral wall 20 into which the engagement section 41 is inserted, and it is possible to effectively prevent the pointer 30 from staggering in the peripheral wall 20 in the peripheral and radial directions by the bottom surface 22b of the fixing recess 22 and the holding portion 24 located in the inside of the bottom surface 22b in the radial direction. Under this condition, the engagement section 41 is inserted into and is engaged with the peripheral wall 20 so as to attach the decorative member 40 to the peripheral wall 20. Consequently, the rear side contact portion 36 of the restriction section 32 on the pointer 30 contacts with the peripheral wall 20 (in more detail, the retraction stopper 23a on the wide recess 23) from the front end side of the portion 36 while the ring-like section 42 of the decorative member 40 contacts with the restriction section 32 (in more detail, the front side contact portion 37 of the restriction section 32) from the front side of the portion 36. Thus, the pointer 30 is prevented from moving in the extending direction of the fixing recess 22 with respect to the knob main body 11. Than is, since the decorative member 40 can restrain the pointer 30, it is possible to prevent the pointer 30 from moving in the extending direction of the fixing recess 22 with respect to the knob main body 11. Accordingly, it is possible to stably hold the pointer 30 in the knob main body 11.

Since, when the rotary knob 10 is mounted on the operation panel P, the front end side of the light emitting surface 33a on the light emitting section 33 of the pointer 30 is exposed outward over the peripheral wall 20 of the knob main body 11 that protrudes from the front surface of the operation panel P (see FIG. 9B), the light emitting surface 33a is not hidden by fingers of the operator even if the peripheral wall 20 is pinched and turned by the operator. Consequently, the operator can continue to view the light emitting surface, 33a upon operation of the rotary knob 10.

Thus, although the rotary knob 10 includes the decorative member 40 for inserting the engagement section 41 into the inside of the peripheral wall 20, the rotary knob 10 has a sufficient internal space and the light emitting surface 33a exposed over the peripheral wall 20 at the front end side of the surface 33a can effect a satisfactory display while the rotary knob 10 holds the pointer 30 stably.

In the present exemplary embodiment, since the pointer 30 is made of the translucent material and the light emitting surface 33a has a transparency lower than that of the incident surface 34, it is easy for the operator to view the position of the light emitting surface 33a, even if the light emitting surface 33a does not emit the lights. That is, if the light emitting surface 33a has a high transparency, the light emitting surface 33a is likely to be seen in the same color as peripheral members, since the color of the peripheral members is likely to be easily seen through the light emitting surface 33a upon non-illumination. Consequently, it is difficult to distinguish the light emitting surface 33a from the peripheral members. On the other hand, if the light emitting surface 33a has a low transparency, the light emitting surface 33a is not seen in the same color as peripheral members, since the color of the peripheral members is difficult to be seen through the light emitting surface 33a. Consequently, it is easy to distinguish the light emitting surface 33a from the peripheral members, even if the light emitting surface 33a does not emit the lights.

On the contrary, if the incident surface 34 has a high transparency, the lights can easily enter the light guide section 31 through the incident surface 34. Consequently, it is possible for the light emitting surface 33a to efficiently emit lights.

In the present exemplary embodiment, since the decorative member 40 includes the supporting portion 141, it is possible to restrain the light guide section 31 of the pointer 30 and the front end side (the front end of the restriction section 32) over the light guide section 31 from moving in the radial direction with respect to the peripheral wall 20, thereby stably holding the pointer 30 in the knob main body 11. That is, since the pointer 30 is prevented from moving in the radial direction at the position apart from the knob main body 11 in the extending direction of the fixing recess 22, it is possible to effectively prevent the pointer 30 from staggering in the radial direction.

It should be noted that the rotary knob of the exemplary embodiments is not limited to the above exemplary embodiments. The rotary knob may be altered into various aspects so long as the alterations fall in a scope of the gist of the exemplary embodiments.

Although the peripheral wall 20 in the above exemplary embodiment is formed into a cylindrical configuration having a constant diameter in the direction of the central axis C, the peripheral wall 20 may not be limited to such configuration. The peripheral wall 20 may be formed into a circular truncated cone in which a diameter decreases in the longitudinal direction. The peripheral wall 20 may not be a cylindrical configuration but a polygonal configuration.

Although the restriction portion 32 of the pointer 30 is continued between the front contact portion 37 and the rear contact portion 36 in the above exemplary embodiment, the restriction portion 32 may not be continued between them. That is, portions that protrude over the light guide section 31 may be provided at the front contact portion 36 and rear contact portion 37.

The exemplary embodiment described above is summarized below.

A rotary knob of the exemplary embodiments is rotatably mounted on a panel. The rotary knob comprises: a knob main body including a tubular peripheral wall that protrudes from a front surface of the panel when the rotary knob is mounted on the panel, the peripheral wall being provided in an inner peripheral surface at a particular position in a peripheral direction of the peripheral wall with a fixing recess that extends from a rear end to a front end of the peripheral wall and is concaved outward in a radial direction of the peripheral wall; a light guide member including a light guide section that extends along the fixing recess so that at least an outer portion of the light guide section in the radial direction is fitted into the fixing recess, a restriction section that is provided on a front end side of the light guide section and restrains the light guide member from moving along an extending direction of the fixing recess with respect to the knob main body, and a light emitting surface that is provided on a front end side of the restriction section, is exposed outward from the rotary knob at a front end side over the peripheral wall, and illuminates when lights enter the light guide section, a rear end surface of the light guide section being adapted to define an incident surface for lights; and a decorative member including an engagement section that is inserted inside the peripheral wall along an inner peripheral surface of the peripheral wall so as to be engaged with the peripheral wall, a ring-like section that covers the peripheral wall so that the front end of the peripheral wall is exposed outward when the engagement section is engaged with the peripheral wall. The fixing recess is defined by a pair of opposed surfaces that are spaced apart from each other in the peripheral direction of the peripheral wall and are faced to each other and by a bottom surface that connects outer ends of the pair of opposed surfaces in the radial direction of the peripheral wall. The light guide section of the light guide member extends along the pair of opposed surfaces so that at least an outer portion of the light guide section in the radial direction of the peripheral wall is fitted into a space between the pair of opposed surfaces. The restriction section includes a contact portion that protrudes in the peripheral direction of the peripheral wall over the light guide section and that contacts with the peripheral wall at a front end side of the contact portion. The engagement section of the decorative member is located inside at least the light guide member in the peripheral direction of the peripheral wall. The decorative member is adapted to prevent the light guide member from moving in the extending direction of the fixing recess with respect to the knob main body when the decorative member is attached to the peripheral wall and the ring-like section contacts with a front end of the restriction section of the light guide member. The peripheral wall includes a holding portion that is provided at a position opposed to the bottom surface of the fixing recess and pinches the light guide section at both sides of the radial direction of the peripheral wall in cooperation with the bottom surface of the fixing recess.

According to the rotary knob constructed above, since the pointer is restrained by the decorative member in which the engagement section is inserted into the inside of the peripheral wall, it is possible to stably attach the light guide member to the knob main body and to carry out a satisfactory display without increasing a thickness of the peripheral wall.

Specifically, since the engagement section of the decorative member is located inside the light guide member in the radial direction in the peripheral wall, the recess (that is, the fixing recess) can effectively position the light guide section, even if a thickness of the peripheral wall is not increased and the light guide section is not surrounded from its outside by the peripheral wall. Thus, even if the engagement section is located inside the peripheral wall in the radial direction, it is possible to restrain the rotary knob from increasing the whole thickness. On the other hand, even if the thin light guide member is combined with such peripheral wall, the fixing recess in the inner peripheral surface on the peripheral wall can pinch the light guide section of the light guide member in the peripheral and radial directions and the decorative member can restrain the light guide member so as to prevent the light guide member from moving in the fixing recess with respect to the knob main body in the extending direction of the fixing recess. Thus, the light guide member can be stably attached to the knob main body.

Specifically, in the peripheral wall in which the engagement section inserted inside the peripheral wall is located inside the light guide member in the radial direction, the fixing recess positions the light guide section, so that the inside of the light guide section in the radial direction is exposed, the thickness of the peripheral wall becomes small in comparison with the case where the light guide section is surrounded from the outside in the radial direction. Since the engagement section is disposed in the vicinity of the inside of the light guide section in the radial direction in the peripheral wall, it is possible to restrain the peripheral wall, light guide member, and engagement section from increasing the whole thickness of them. Consequently, it is possible to maintain a size of an internal space defined in the rotary knob. In addition, the pair of opposed surfaces in the fixing recess can pinch both sides of at least the outer side part of the light guide section in the radial direction regardless the thin portion of the peripheral wall into which the engagement section is inserted, and it is possible to effectively prevent the light guide member from staggering in the peripheral wall in the peripheral and radial directions by the bottom surface of the fixing recess and the holding portion located in the inside of the bottom surface in the radial direction. Under this condition, the engagement section is inserted into and is engaged with the peripheral wall so as to attach the decorative member to the peripheral wall. Consequently, the rear side contact portion of the restriction section on the light guide member contacts with the peripheral wall from the front end side of the portion while the ring-like section of the decorative member contacts with the restriction section from the front side of the portion. Thus, the light guide member is prevented from moving in the extending direction of the fixing recess with respect to the knob main body. That is, since the decorative member can restrain the light guide member, it is possible to prevent the light guide member from moving in the extending direction of the fixing recess with respect to the knob main body. Accordingly, it is possible to stably hold the light guide member in the knob main body.

Since, when the rotary knob is mounted on the operation panel, the front end side of the light emitting surface on the light emitting section of the light guide member is exposed outward over the peripheral wall of the knob main body that protrudes from the front surface of the operation panel, the light emitting surface is not hidden by fingers of the operator even if the peripheral wall is pinched and turned by the operator. Consequently, the operator can continue to view the light emitting surface upon operation of the rotary knob.

Thus, although the rotary knob includes the decorative member for inserting the engagement section into the inside of the peripheral wall, the rotary knob has a sufficient internal space and the light emitting surface exposed over the peripheral wall at the front end side of the surface can effect a satisfactory display while the rotary knob holds the light guide member stably.

In the rotary knob, the light guide member is made of, for example, a translucent material. The light emitting surface has a transparency lower than that of the incident surface.

According to the above construction, it is possible to view the position of the light emitting surface even if the light emitting surface does not emit the lights. That is, if the light emitting surface has a high transparency, the light emitting surface is likely to be seen in the same color as peripheral members, since the color of the peripheral members is likely to be easily seen through the light emitting surface upon non-illumination. Consequently, it is difficult to distinguish the light emitting surface from the peripheral members. On the other hand, if the light emitting surface has a low transparency, the light emitting surface is not seen in the same color as peripheral members, since the color of the peripheral members is difficult to be seen through the light emitting surface. Consequently, it is easy to distinguish the light emitting surface from the peripheral members, even if the light emitting surface does not emit the lights.

On the contrary, if the incident surface has a high transparency, the lights can easily enter the light guide section through the incident surface. Consequently, it is possible for the light emitting surface to efficiently emit lights.

In the rotary knob, the decorative member includes, for example, a support portion at a position on the engagement section that is opposed to a front end portion of the light guide section. The supporting portion includes a front end that extends outward from the engagement section in the radial direction of the peripheral wall and that contacts with the inner surface of the peripheral wall in the radial direction so that a front end of the light guide member over the light guide section is pressed onto the peripheral wall when the decorative member is attached to the peripheral wall.

Thus, it is possible to restrain the light guide section of the light guide member and the front end side over the light guide section from moving in the radial direction with respect to the peripheral wall, thereby stably holding the light guide member in the knob main body. That is, since the light guide member is prevented from moving in the radial direction at the position apart from the knob main body in the extending direction of the fixing recess, it is possible to effectively prevent the light guide member from staggering in the radial direction.

As described above, the rotary knob of the exemplary embodiments can be effectively utilized in a rotary knob to be mounted on an operation panel in a vehicle room. Even if a part of the decorative member is inserted into and is attached to the knob main body, it is possible to ensure a sufficient internal space in the rotary knob and it is possible for the light guide member to carry out a stable and satisfactory display after the light guide member is attached to the knob main body.

1. A rotary knob having a front end side, the rotary knob to be rotatably mounted on a panel having a front surface, the rotary knob comprising:
a knob main body including
a tubular peripheral wall configured to protrude from the front surface of the panel when the rotary knob is mounted on the panel, the peripheral wall including a front end, a rear end, and an inner peripheral surface having a fixing recess configured to extend from the rear end of the peripheral wall to the front end of the peripheral wall, wherein the inner peripheral surface is concaved outward in a radial direction of the peripheral wall;
a light guide member including
a light guide section having a front end side and a rear end surface, the light guide section being configured to extend along the fixing recess so that at least an outer portion of the light guide section in the radial direction fits into the fixing recess,
a restriction section having a front end side, the restriction section being provided on the front end side of the light guide section and configured to restrain the light guide member from moving along an extending direction of the fixing recess with respect to the knob main body, and
a light emitting surface provided on the front end side of the restriction section, extends outward from the rotary knob at the front end side of the rotary knob such that the light emitting surface extends over the peripheral wall, and is configured to illuminate when light enters the light guide section, the rear end surface of the light guide section defining an incident surface for light to enter; and
a decorative member including
an engagement section configured to be inserted inside the peripheral wall along the inner peripheral surface and to engage with the peripheral wall,
a ring-like section configured to cover the front end of the peripheral wall, the peripheral wall extending outward when said engagement section is engaged with said peripheral wall, wherein
the fixing recess is defined by a pair of opposed surfaces that are spaced apart from each other in a circumferential direction of the peripheral wall and a bottom surface that connects outer ends of the pair of opposed surfaces in the radial direction of the peripheral wall;
the light guide section extends along the pair of opposed surfaces such that at least an outer portion of the light guide section in the radial direction of the peripheral wall is fitted into a space defined by the pair of opposed surfaces,
the restriction section includes a contact portion configured to protrude in the circumferential direction of the peripheral wall over the light guide section and contact the peripheral wall at a front end side of the contact portion;
the engagement section of the decorative member is located inside at least the light guide member in the radial direction of the peripheral wall;
the decorative member is configured to prevent the light guide member from moving in the extending direction of the fixing recess with respect to the knob main body when the decorative member is attached to the peripheral wall and the ring-like section contacts a front end of the restriction section of the light guide member; and
the peripheral wall includes a holding portion provided at a position opposed to the bottom surface of the fixing recess and configured to pinch the light guide section at both sides of in the radial direction of the peripheral wall in cooperation with the bottom surface of the fixing recess.

2. A rotary knob according to claim 1, wherein the light guide member is translucent and the light emitting surface has a transparency lower than that of the incident surface.

3. A rotary knob according to claim 1, wherein
the decorative member includes a support portion at a position on the engagement section that is opposed to a front end portion of the light guide section; and
the supporting portion includes a front end that is configured to extend outward from the engagement section in the radial direction of the peripheral wall and that contacts the inner surface of the peripheral wall in the radial direction thereby pressing a front end of the light guide member over the light guide section towards the peripheral wall when the decorative member is attached to the peripheral wall.

4. A rotary knob according to claim 2, wherein
the decorative member includes a support portion at a position on the engagement section that is opposed to a front end portion of the light guide section; and
the supporting portion includes a front end that is configured to extend outward from the engagement section in the radial direction of the peripheral wall and that contacts the inner surface of the peripheral wall in the radial direction thereby pressing a front end of the light guide member over the light guide section towards the peripheral wall when the decorative member is attached to the peripheral wall.
